(19) United States
(12) Patent Application Publication
(10) Pub. No.: US 2007/0069983 A1
(43) Pub. Date: Mar. 29, 2007

(54) Method and apparatus for driving plasma display panel and plasma display device driven using the method and apparatus

(76) Inventor: Hak-Ki Choi, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 11/526,666

(22) Filed: Sep. 26, 2006

(30) Foreign Application Priority Data
Sep. 27, 2005 (KR) 10-2005-0089694

(51) Int. Cl. G09G 3/28

(52) U.S. Cl. 345/60

(57) ABSTRACT

A method of driving a PDP, in which discharge cells are defined in regions where a plurality of electrodes cross one another and a unit frame displaying an image is divided into a plurality of subfields, each subfield including a reset period for initializing all discharge cells, an address period for selecting discharge cells to be turned on, and a sustain period for performing a sustain discharge in the selected discharge cells according to a gray scale weight allocated to each subfield, including applying a falling pulse to first electrodes among the plurality of electrodes during the reset period, and changing a lowest level of the falling pulse according to a temperature of the PDP. An apparatus configured to drive a PDP, which includes zener diodes to implement the method, and a plasma display device driven using the method and apparatus.

### BACKGROUND OF THE INVENTION

1. Field of the Invention

The present invention relates to a method and apparatus for driving a plasma display panel (PDP), and a plasma display device driven using the method and apparatus. More particularly, the present invention relates to a method and apparatus for driving a PDP, and a plasma display device driven using the method and apparatus, which collectively enable the PDP to stably perform a discharge, despite varying discharge characteristics of the PDP according to the temperature of the PDP.

2. Description of the Related Art

Plasma display panels (PDPs) have received a lot of attention in the industry as the next-generation display panel. In a PDP, a discharge gas is filled between two substrates on which a plurality of electrodes are formed, a discharge voltage is applied to the electrodes, a luminescent material, such as phosphor, formed with a predetermined pattern, is excited due to ultraviolet rays generated by the discharge voltage, and thus a desired image is displayed.

FIG. 1 illustrates a timing diagram of driving signals of a PDP. A unit frame displaying an image may be divided into a plurality of subfields, and each subfield may include a reset period PR, an address period PA, and a sustain period PS. During the reset period PR, the states of wall charges in all discharge cells may be initialized. During the address period PA, discharge cells to be turned on may be selected. During the sustain period PS, a sustain discharge may be performed according to a gray scale weight allocated to each subfield.

Specifically, referring to FIG. 1, in the reset period PR, a rising ramp pulse and a falling ramp pulse may be applied to scan electrodes Y₁, . . . , Yₙ, and a bias voltage may be applied to sustain electrodes X₁, . . . , Xₙ, from when the falling ramp pulse is applied to the scan electrodes Y₁, . . . , Yₙ. During the address period PA, scan pulses may be sequentially applied to the scan electrodes Y₁, . . . , Yₙ, and a display data signal is transmitted to address electrodes A₁, . . . , Aₘ in synchronization with the scan pulses. During the sustain period PS, sustain pulses may be alternately applied to the scan electrodes Y₁, . . . , Yₙ, and the sustain electrodes X₁, . . . , Xₙ.

By transmitting these driving signals to each electrode as described above, a reset discharge, an address discharge, and a sustain discharge may be performed in the reset period PR, the address period PA, and the sustain period PS, respectively. However, the discharge characteristics of the PDP may vary according to the temperatures thereof. In other words, the PDP may show different discharge characteristics when its temperature is, for example, normal, high or low, according to the structure of the PDP and a gas division rate. For example, when the temperature of a PDP is relatively normal, the PDP may exhibit normal discharge characteristics. However, when the temperature of the PDP is high, the PDP may exhibit low discharge characteristics, and when the temperature of the PDP is low, the PDP may exhibit over discharge characteristics. Accordingly, when the discharge characteristics of PDPs vary according to temperatures thereof, PDPs may fail to perform discharge in a stable manner, which, in turn, hinders the PDPs from providing high-quality images.

### SUMMARY OF THE INVENTION

The present invention is therefore directed to a method and apparatus for driving a plasma display panel (PDP), and a plasma display device driven using the method and apparatus, which substantially overcome one or more of the problems due to the limitations and disadvantages of the related art.

It is therefore a feature of an exemplary embodiment of the present invention to provide a PDP that stably performs a discharge despite varying discharge characteristics of the PDP according to the temperature of the PDP.

At least one of the above and other features and advantages of the present invention may be realized by providing a method of driving a PDP, in which discharge cells may be defined in regions where a plurality of electrodes cross one another and a unit frame displaying an image may be divided into a plurality of subfields, each subfield including a reset period for initializing all discharge cells, an address period for selecting discharge cells to be turned on, and a sustain period for performing a sustain discharge in the selected discharge cells according to a gray scale weight allocated to each subfield, the method including applying a falling pulse to first electrodes among the plurality of electrodes during the reset period, and changing a lowest level of the falling pulse according to a temperature of the PDP.

The lowest level of the falling pulse may become higher as the temperature of the PDP increases.

When the temperature of the PDP is higher than a first temperature, the lowest level of the falling pulse may be a first level, and when the temperature of the PDP is lower than the first temperature, the lowest level of the falling pulse may be a second level, the second level being lower than the first level.

When the temperature of the PDP is lower than a second temperature, the second temperature being lower than the first temperature, the lowest level of the falling pulse may be a third level, and when the temperature of the PDP is lower than the first temperature, but higher than the second temperature, the lowest level of the falling pulse may be the second level, the second level being higher than the third level.

Applying a rising pulse to the first electrodes before applying the falling pulse to the first electrodes.

Applying a high level voltage to the first electrodes, sequentially applying a scan pulse having a low level to the first electrodes during the address period, and transmitting a display data signal having a high level to second electrodes among the plurality of electrodes, in synchronization with the scan pulse, where the second electrodes cross the first electrodes.

Alternately applying a sustain pulse to the first electrodes during the sustain period, the sustain pulse alternating between a high level and a low level

Applying a sustain pulse to third electrodes among the plurality of electrodes, the sustain pulse alternating between a high level and a low level, and alternates with the sustain pulse applied to the first electrodes during the sustain period, where the third electrodes extend parallel to the first electrodes.

Applying a bias voltage to the third electrodes when the falling pulse is applied to the first electrodes.

At least one of the above and other features and advantages of the present invention may be realized by providing an apparatus configured to drive a PDP, the apparatus may include a first voltage source configured to supply a first voltage, a first voltage switching device including a terminal connected to the first voltage source, at least one falling switching device including terminals connected to the first voltage source in parallel, zener diodes respectively connected to the other terminal of the at least one falling switching device, and a falling pulse applying unit configured to output a falling pulse which falls to a first voltage when the first voltage switching device is turned on, where the first voltage is a lowest level voltage, and the falling pulse unit is configured to change a lowest level of the falling pulse according to a temperature of the PDP, using the zener diodes having different zener voltages.

The apparatus may include a falling switching device connected to a zener diode having a high zener voltage among the zener diodes, where as the temperature of the PDP increases, the falling switch device is configured to be turned on, and the lowest level of the falling pulse may be changed.

The apparatus may further include a second voltage source and a ground respectively configured to supply a second voltage and a ground voltage, a second voltage switching device including a terminal connected to the second voltage source, a ground voltage switching device including a terminal connected to the ground and the other terminal connected to the other terminal of the second voltage switching device, and a sustain pulse applying unit configured to output a sustain pulse when the second voltage switching device and the ground voltage switching device are alternately turned on.

The apparatus may further include a third voltage source configured to supply a third voltage, a first capacitor and a third voltage switching device connected to the third voltage source in parallel, a main switching device connected between the first capacitor and the third voltage switching device, and a rising pulse applying unit configured to receive a voltage from the sustain pulse applying unit and output a rising pulse which rises to the third voltage.

The apparatus may further include a fourth voltage source configured to supply a fourth voltage, a second capacitor including a terminal connected to the fourth voltage source, a fifth voltage source configured to supply a fifth voltage, a fifth voltage switching device connected to the fifth voltage source and the other terminal of the second capacitor, a scan high switching device and a scan low switching device connected to each other in series between both terminals of the second capacitor, and a scan pulse applying unit configured to output the fifth voltage when the scan high switching device is turned on and output a scan pulse having the fifth voltage when the fifth voltage switching device and the scan low switching device are turned on.

The first voltage source may serve as a fifth voltage source.

The apparatus may further include an inductor having a terminal connected between the second voltage switching device and the ground switching device of the sustain pulse applying unit, the inductor including another terminal connected between an energy recovery switching device and an energy supply switching device, where terminals of the energy supply switching device are connected to the inductor in parallel, an energy storage capacitor connected among the other respective terminals of the energy recovery switching device, the energy supply switching device, and the ground, and an energy recovery unit configured to collect charges from the PDP or supply the charges to the PDP while the sustain pulse is applied.

At least one of the above and other features and advantages of the present invention may be realized by providing a plasma display device which may include a PDP, a logic controller configured to process an input signal and output a driving control signal, a driver configured to receive the driving control signal and output a driving signal to the PDP, and a temperature sensor configured to sense a temperature inside the PDP, where the driver outputs the driving signal having a lowest level, and the lowest level is changed according to the sensed temperature of the plasma display panel.

The driver may include a plurality of falling switching devices connected to a voltage source and zener diodes, where as the temperature of the plasma display panel increases, a falling switching device of the plurality of falling switching devices, connected to a zener diode having a high zener voltage among the zener diodes, is turned on.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 illustrates a timing diagram of driving signals of a plasma display panel (PDP);

FIG. 2 illustrates an electrode arrangement of a PDP configured to be driven by an apparatus and a method for driving a PDP according to an exemplary embodiment of the present invention;

FIG. 3 illustrates a zener diode employable in the apparatus configured to drive a PDP according to an exemplary embodiment of the present invention;

FIG. 4 illustrates a block diagram of an apparatus configured to drive a PDP according to an exemplary embodiment of the present invention;

FIG. 5 illustrates an exemplary circuit diagram of the Y driver in FIG. 4;

FIG. 6 illustrates a timing diagram of a method of driving a PDP employed by the apparatus of FIG. 5 according to an exemplary embodiment of the present invention;

FIG. 7 illustrates a circuit diagram of an apparatus configured to drive a PDP according to another exemplary embodiment of the present invention; and

FIG. 8 illustrates a timing diagram of a method of driving a PDP employed by the apparatus of FIG. 7 according to another exemplary embodiment of the present invention.

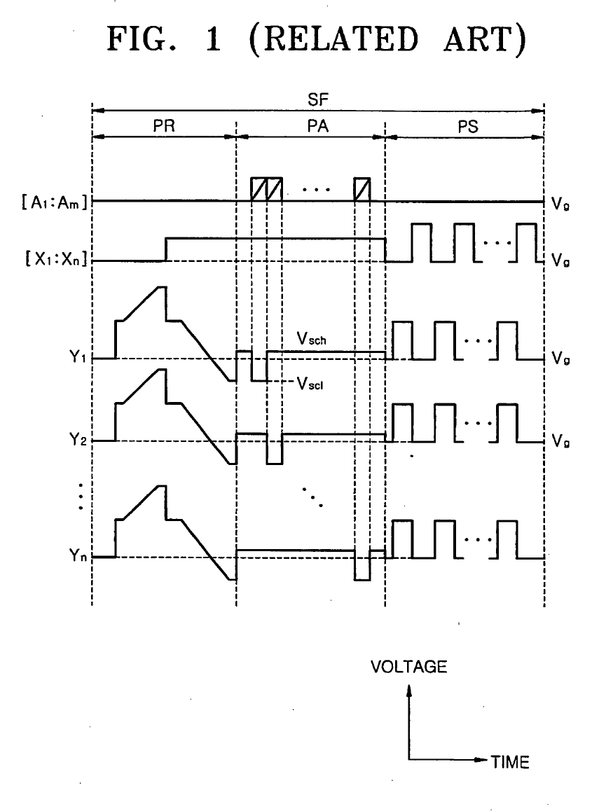

### DETAILED DESCRIPTION OF THE INVENTION

Korean Patent Application No. 10-2005-0089694, filed on Sep. 27, 2005, in the Korean Intellectual Property Office, and entitled, “Method and Apparatus for Driving Plasma Display Panel and Plasma Display Device Driven Using the Method and Apparatus,” is incorporated by reference herein in its entirety.

The present invention will now be described more fully hereinafter with reference to the accompanying drawings, in which exemplary embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art.

In the figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as “covering” another layer, it can be directly covering, or one or more intervening layers may also be present. In addition, it will also be understood that when an element is referred to as connected “between” two elements, it can be the only element between the two elements, or one or more elements may also be present. Like reference numerals refer to like elements throughout.

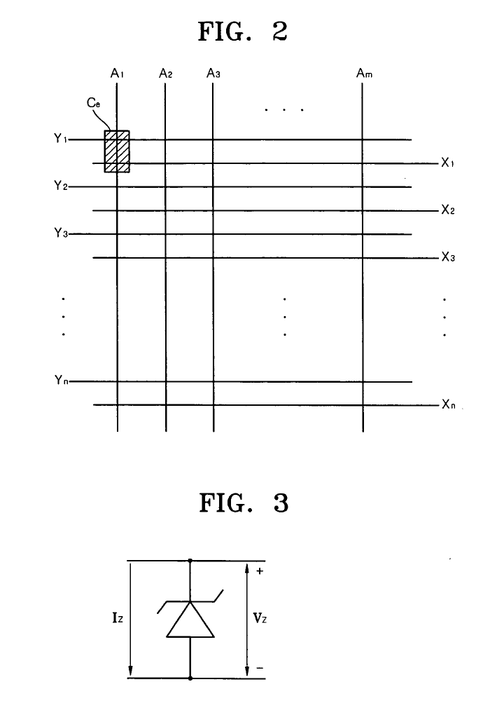

FIG. 2 illustrates an electrode arrangement of a PDP configured to be driven using an apparatus and method for driving a PDP according to an exemplary embodiment of the present invention.

Referring to FIG. 2, the PDP of a plasma display device driven using the method and apparatus may include a first substrate and a second substrate (not illustrated) separated from each other. A first dielectric layer (not illustrated) may cover scan electrodes and sustain electrodes, which may be separated from and extend parallel to one another, and a first protective layer (not illustrated) may protect the first dielectric layer and may be on a rear surface of the first substrate. The scan electrodes and the sustain electrodes may include a plurality of sustain electrode pairs, and each of the scan electrodes and each of the sustain electrodes may be configured, respectively, by coupling metallic bus electrodes (not illustrated), which may enhance conductivity, and transparent electrodes (not illustrated), which may include a transparent conductive material, such as Indium Tin Oxide (ITO).

A second dielectric layer (not illustrated) may cover address electrodes and may be on the second substrate. The address electrodes may cross the scan electrodes and the sustain electrodes as indicated by Cₑ. The second substrate may further include barrier ribs (not illustrated) defining discharge cells, luminescent layers (not illustrated), such as phosphor layers, may be provided inside the discharge cells defined by the barrier ribs, and a second protective layer (not illustrated) may be on a front surface of the phosphor layers to protect the phosphor layers. The second protective layer may also be on the second dielectric layer. The discharge cells defined by the barrier ribs may be filled with a discharge gas.

The PDP according to the present invention can have various structures in addition to the structure described above.

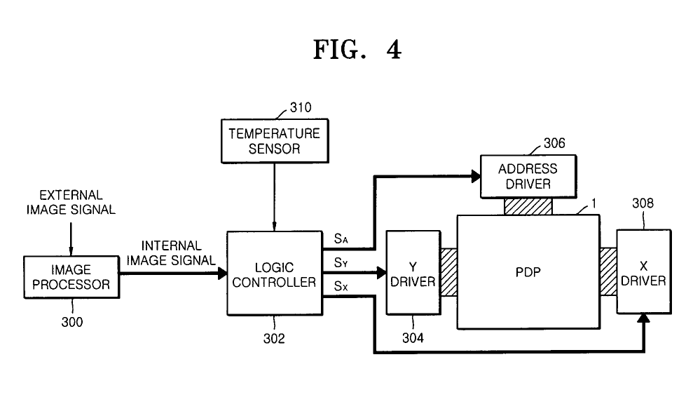

FIG. 3 illustrates a zener diode employable in the apparatus for driving a PDP according to an exemplary embodiment of the present invention. FIG. 3 illustrates electrical characteristics of the zener diode. When a current Iz flows between both terminals of an anode and a cathode included in the zener diode, a predetermined potential difference, that is, a voltage drop corresponding to a zener voltage Vz, may occur at both terminals of the anode and the cathode. The zener voltage Vz may vary according to characteristics of the zener diode. Therefore, the present invention may employ zener diodes having different zener voltages, according to the temperature of a PDP, such that the PDP may exhibit uniform discharge characteristics.

FIG. 4 illustrates a block diagram of an apparatus configured to drive a PDP according to an exemplary embodiment of the present invention.

Referring to FIG. 4, the apparatus may include an image processor 300, a logic controller 302, a Y driver 304, an address driver 306, an X driver 308, a temperature sensor 310, and a PDP 1.

The image processor 300 may convert external signals into digital signals. The external signals, such as analog image signals, may include PC signals, DVD signals, video signals and TV signals. The image processor 300 may process the digital signals and generate internal image signals. The internal image signals may include red (R), green (G), and blue (B) image data, each having a certain number of bits, such as 8 bits. The internal image signals may also include clock signals, and vertical and horizontal synchronization signals.

The logic controller 302 may receive the internal image signals from the image processor 300, and may perform correction, such as gamma correction, and automatic power control (APC) operations on the received internal image signals, and may generate Y, address, and X driving control signals S_{Y}, S_{A}, and S_{X}.

The Y driver 304 may receive the Y driving control signal S_{Y} from the logic controller 302 and may transmit Y driving control signal S_{Y} to the scan electrodes Y₁, . . . , Yₙ of FIG. 2. The address driver 306 may receive the address driving control signal S_{A} from the logic controller 302, and may transmit the address driving control signal S_{A} to the address electrodes A₁, . . . , Aₘ of FIG. 2. The X driver 308 may receive X driving control signal S_{X} from the logic controller 302 and may transmit the X driving control signal S_{X} to the sustain electrodes X₁, . . . , Xₙ of FIG. 2.

The temperature sensor 310 may sense the temperature of the PDP 1. Information regarding the temperature of the PDP 1, which is sensed by the temperature sensor 310, may be input to the logic controller 302. The logic controller 302 may transmit a driving control signal to a driver according to the temperature of the PDP 1, so that the PDP 1 may exhibit uniform discharge characteristics despite the temperature changes of the PDP 1. For example, the logic controller 302 may transmit a Y driving control signal S_{Y} to the Y driver 304 to vary a lowest level of a falling pulse.

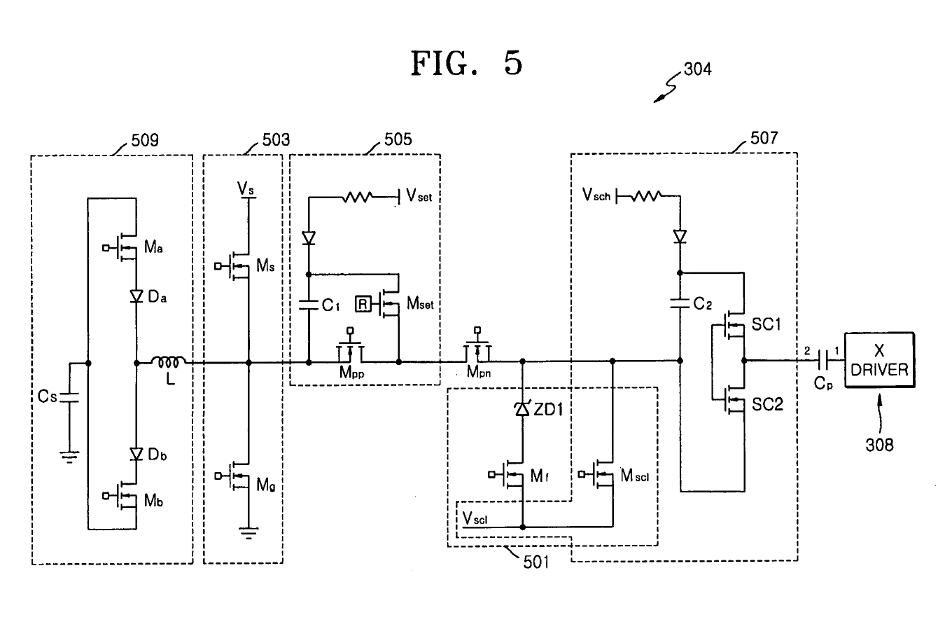

FIG. 5 illustrates an exemplary circuit diagram of the Y driver of FIG. 4.

Referring to FIG. 5, the apparatus includes the Y driver 304 and the X driver 308 connected respectively to second and first terminals of a panel capacitor Cₚ (i.e., the PDP 1 is modelled as a capacitor in the circuit diagram of FIG. 5, for illustrative purposes only). FIG. 5 illustrates a detailed exemplary circuit diagram of the Y driver 304.

The Y driver 304 may include a falling pulse applying unit 501 configured to generate a falling pulse, a sustain pulse applying unit 503 configured to generate a sustain pulse, a rising pulse applying unit 505 configured to generate a rising pulse, a scan pulse applying unit 507 configured to generate a scan pulse, and an energy recovery unit 509 configured to collect wall charges (energy) from the panel capacitor Cₚ, store the wall charges (energy), and supply the stored wall charges (energy) to the panel capacitor Cₚ.

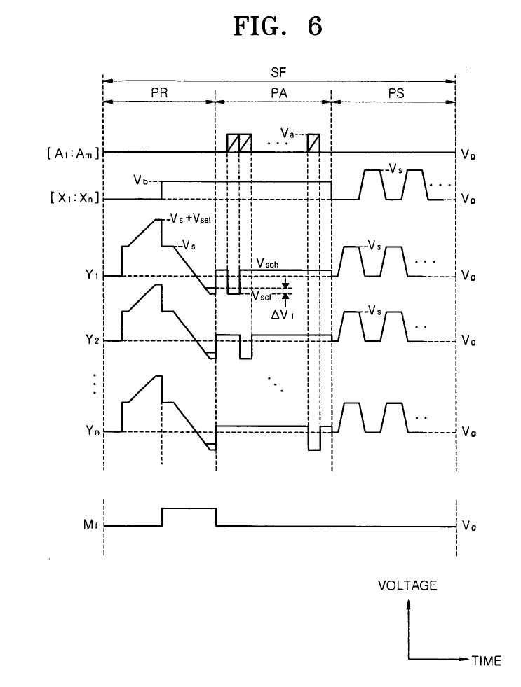

The sustain pulse applying unit 503 may include a second voltage source Vₛ, i.e., a sustain discharge voltage source, a voltage switching device Mₛ, and a ground voltage switching device M_{g}. The voltage switching device Mₛ may have a terminal connected to the second voltage source Vₛ. The ground voltage switching device M_{g} may have a terminal connected to the other terminal of the voltage switching device Mₛ. A ground may be connected to the other terminal of the ground voltage switching device M_{g}. The second voltage switching device Mₛ and the ground voltage switching device M_{g} may be alternately turned on to apply a sustain pulse. The sustain pulse applying unit 503 may apply a sustain pulse during a sustain period PS of FIG. 6. The sustain pulse may include the second voltage, i.e., the sustain discharge voltage Vₛ, and the ground voltage V_{g}, in an alternating manner.

The rising pulse applying unit 505 may include a third voltage source Vₛₑₜ, a first capacitor C₁, a third voltage switching device Mₛₑₜ, and a main switching device Mₚₚ. The third voltage source Vₛₑₜ may supply a third voltage. The third voltage switching device Mₛₑₜ may be connected to the main switching device Mₚₚ in parallel. The main switching device Mₚₚ may be connected between the first capacitor C₁ and the third voltage switching device Mₛₑₜ. To output a rising pulse, the second voltage switching device Mₛ of the sustain pulse applying unit 503 may be turned on and the main switching device Mₚₚ may be turned off. After the first capacitor C₁ is charged with the second voltage Vₛ of the sustain pulse applying unit 503, the third voltage switching device Mₛₑₜ may be turned on. The rising pulse applying unit 505 may apply a rising pulse during a reset period PR of FIG. 6. The rising pulse may rise from the second voltage, i.e., the sustain discharge voltage Vₛ, to the third voltage, i.e., the rising voltage Vₛₑₜ, and may reach a highest rising voltage Vₛ+Vₛₑₜ.

The falling pulse applying unit 501 may include a first voltage source V_{scl}, a first voltage switching device M_{scl}, a falling switching device M_{f}, and a zener diode ZD1. The falling switching device M_{f} may have terminals connected to the first voltage source V_{scl} in parallel. The zener diode ZD1 may be connected to the other terminal of the falling switching device M_{f}. When the temperature of the PDP 1 is higher than a predetermined temperature, the falling switching device M_{f} may be turned on such that a voltage higher than the first voltage may be output. That is, the higher voltage is a zener voltage, the first voltage being a lowest falling voltage V_{scl}. When the temperature of the PDP 1 is lower than the predetermined temperature, the first voltage switching device M_{scl} may be turned on such that the lowest falling voltage V_{scl} may be output. The falling pulse applying unit 501 may apply a falling pulse during the reset period PR as illustrated in FIG. 6. The falling pulse may fall from the second voltage, i.e., the sustain discharge voltage Vₛ, to a first voltage, i.e., the lowest voltage V_{scl}.

In FIG. 6, the lowest level of the falling pulse may vary according to the temperature of the PDP 1. For example, the lowest level of the falling pulse may vary only when the temperature of the PDP 1 is higher or lower than a predetermined temperature.

The scan pulse applying unit 507 may include a fourth voltage source V_{sch}, a second capacitor C₂, a fifth voltage source V_{scl}, a fifth voltage switching device M_{scl}, a scan high switching device SC1, and a scan low switching device SC2. In the exemplary embodiment illustrated in FIG. 5, the first voltage source V_{scl} of the falling pulse applying unit 501 serves as the fifth voltage source. The second capacitor C₂ may have a terminal connected to the fourth voltage source V_{sch}. The fifth voltage switching device M_{scl} may be connected between the fifth voltage source V_{scl} and the second capacitor C₂. The scan high switching device SC1 and the scan low switching device SC2, may be connected in series between both terminals of the second capacitor C₂. That is, the scan high switching device SC1 and the scan low switching device SC2, may be connected between the fifth voltage switching device M_{scl} and the fourth voltage source V_{sch}.

An exemplary operation of the scan pulse applying unit 507 will now be discussed. For example, initially, the scan high switching device SC1 may be turned on and the scan low switching device SC2 may be turned off. Then, the scan high switching device SC1 may be turned off and the scan low switching device SC2 may be turned on for a predetermined period of time. Thereafter, the scan high switching device SC1 may be turned on again and the scan low switching device SC2 may be turned off. Based on this exemplary operation, the scan pulse applying unit 507 may apply a scan pulse during an address period PA of FIG. 6. The scan pulse may include a fourth voltage, i.e., a scan high voltage V_{sch}, and a fifth voltage, i.e., a scan low voltage V_{scl}, for each electrode sequentially.

In FIG. 5, the first voltage source V_{scl} and the fifth voltage source V_{scl} are used together, and the first voltage switching device M_{scl} and the fifth voltage switching device M_{scl} are used together. However, they may be used separately.

The energy recovery unit 509 may include an inductor L, an energy recovery switching device M_{b}, an energy supply switching device Mₐ, and an energy storage capacitor Cₛ. A terminal of the inductor L may be connected between the second voltage switching device Mₛ and the ground voltage switching device M_{g} of the sustain pulse applying unit 503. Therefore, the inductor L may have LC resonance with the panel capacitor Cₚ. The other terminal of the inductor L may be connected between the energy supply switching device Mₐ and the energy recovery switching device M_{b}. The energy recovery switching device M_{b} may connect to the inductor L in parallel, and may collect wall charges (energy) from the panel capacitor Cₚ. The energy supply switching device Mₐ may output the wall charges (energy), collected and stored in the energy storage capacitor Cₛ, back to the panel capacitor Cₚ. The energy storage capacitor Cₛ may be connected between the other terminals of the energy recovery switching device M_{b} and the energy supply switching deice Mₐ, and the ground. The energy storage capacitor Cₛ may store the collected wall charges (energy).

The energy recovery unit 509 may collect wall charges (energy) remaining in the panel capacitor Cₚ or may output the collected wall charges (energy) back to the panel capacitor Cₚ during the sustain period PS when a sustain pulse may be applied, thereby reducing energy consumption. For example, when the sustain pulse rises from the ground voltage V_{g} to the sustain discharge voltage Vₛ, the energy supply switching device Mₐ may be turned on. When the sustain pulse falls from the sustain discharge voltage Vₛ to the ground voltage V_{g}, the energy recovery switching device M_{b} may be turned on.

FIG. 6 illustrates a timing diagram of a method of driving a PDP employed by the apparatus of FIG. 5 according to an exemplary embodiment of the present invention.

A unit frame, forming an image, may be divided into a plurality of subfields, and each subfield may include the reset period PR, the address period PA, and the sustain period PS. During the reset period PR, the states of the wall charges in all discharge cells may be initialized. During the address period PA, discharge cells to be turned on may be selected. During the sustain period PS, a sustain discharge may be performed according to a gray scale weight allocated to each subfield.

Referring to FIGS. 5 and 6, in the reset period PR, a rising pulse and a falling pulse may be applied to scan electrodes Y₁, . . . , Yₙ, and a bias voltage V_{b} may be applied to sustain electrodes X₁, . . . , Xₙ from when the falling pulse is applied to the scan electrodes Y₁, . . . , Yₙ. In addition, a ground voltage V_{g} may be applied to address electrodes A₁, . . . , Aₘ. The rising pulse gradually rises from the sustain discharge voltage Vₛ to the rising voltage Vₛₑₜ and reaches the highest rising voltage Vₛ+Vₛₑₜ. The falling pulse falls from the sustain discharge voltage Vₛ to the lowest falling voltage V_{scl}. When the rising pulse is applied, a weak reset discharge may occur since wall charges with negative polarity may accumulate around the scan electrodes Y₁, . . . , Yₙ of the discharge cells. When the falling pulse is applied, the wall charges with negative polarity, which have accumulated around the scan electrodes Y₁, . . . , Yₙ of the discharge cells, may be removed, and the wall charges with negative polarity may accumulate around the sustain electrodes X₁, . . . , Xₙ. In so doing, a weak reset discharge occurs. When the reset period PR is terminated, an appropriate amount of wall charges may remain so that an address discharge may be performed in the subsequent address period PA.

As discussed above, the present invention may solve the problem of varying discharge characteristics of the PDP 1 according to the temperature of the PDP 1. In particular, over discharge may occur when the temperature of the PDP 1 is low (e.g., lower than a predetermined temperature), whereas a low-discharge may occur when the temperature of the PDP 1 is high (e.g., higher than the predetermined temperature).

To solve this problem, the present invention varies the lowest level of the falling pulse according to the temperature of the PDP 1. In other words, when the temperature of the PDP 1 is high, the lowest level of the falling pulse may be raised such that the amount of wall discharges removed from around the scan electrodes Y₁, . . . , Yₙ is less, than when the temperature of the PDP 1 is a normal temperature, thereby resolving the problem of the low-discharge. Conversely, when the temperature of the PDP 1 is low, the lowest level of the falling pulse may be lowered such that the amount of wall discharges removed from around the scan electrodes Y₁, . . . , Yₙ is higher, than when the temperature of the PDP 1 is the normal temperature, thereby resolving the problem of over discharge.

In FIG. 6, a temperature section of the PDP 1 is divided into two sections. When the temperature of the PDP 1 is higher than a predetermined temperature, the lowest level of the falling pulse may be raised from the lowest falling voltage V_{scl} by a predetermined potential difference ΔV1. When the temperature of the PDP 1 is lower than the predetermined temperature, the lowest level of the falling pulse may be lowered to the lowest falling voltage V_{scl}.

During the address period PA, a high level voltage, that is, the scan high voltage V_{sch}, may be applied to the scan electrodes Y₁, . . . , Yₙ. Also, a scan pulse having a low level voltage, that is, the scan low voltage V_{scl}, may be sequentially applied to the scan electrodes Y₁, . . . , Yₙ for a predetermined period of time. A display data signal having a high level voltage, that is, an address voltage Vₐ, may be transmitted to the address electrodes A₁, . . . , Aₘ in synchronization with the scan pulse. In addition, the bias voltage V_{b} may be applied to the sustain electrodes X₁, . . . , Xₙ. The address discharge may be performed in the discharge cells to be turned on, in response to the scan pulse and the display data signal. Wall discharges with positive polarity may accumulate around the scan electrodes Y₁, . . . , Yₙ of the discharge cells, and the wall charges with negative polarity may accumulate around the sustain electrodes X₁, . . . , Xₙ, such that the sustain discharge may be performed in the sustain period PS. During the reset period PR, since the amount of wall charges in the discharge cells may be controlled according to the temperature of the PDP 1, a uniform address discharge may be performed regardless of the temperature of the PDP 1. In other words, over discharge or low discharge does not occur.

During the sustain period PS, a sustain pulse may have a high level voltage, that is, the sustain discharge voltage Vₛ, and a low level voltage, that is, the ground voltage V_{g}. The sustain pulse may be alternately applied to the scan electrodes Y₁, . . . , Yₙ and the sustain electrodes X₁, . . . , Xₙ. During the sustain period PS, the sustain discharge may be performed due to the sustain discharge voltage Vₛ, the ground voltage V_{g}, and the wall charges accumulated around the sustain electrodes X₁, . . . , Xₙ and the scan electrodes Y₁, . . . , Yₙ. The polarities of the wall charges accumulated around the sustain electrodes X₁, . . . , Xₙ and the scan electrodes Y₁, . . . , Yₙ may be continuously changed by the sustain pulse. Since the address discharge may be performed uniformly regardless of the temperature of the PDP 1, the sustain discharge may also performed uniformly.

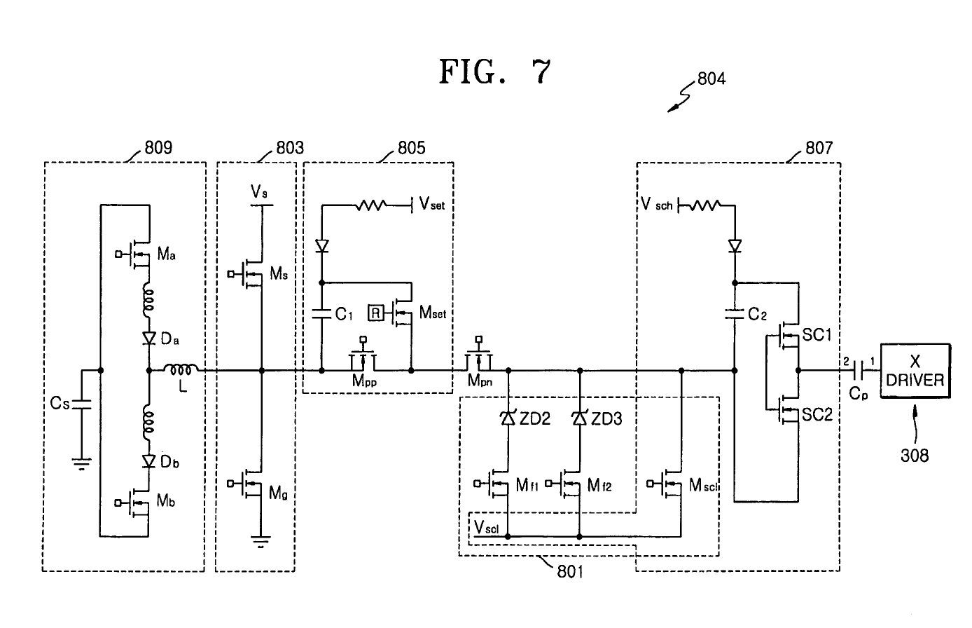

FIG. 7 illustrates a circuit diagram of an apparatus configured to drive a PDP according to another exemplary embodiment of the present invention.

The apparatus of FIG. 7 is similar to the apparatus of FIG. 5, and may include a Y driver 804 and the X driver 308. The Y driver 804 may include a falling pulse applying unit 801 configured to generate a falling pulse, a sustain pulse applying unit 803 configured to generate a sustain pulse, a rising pulse applying unit 805 configured to generate a rising pulse, a scan pulse applying unit 807 configured to generate a scan pulse, and an energy recovery unit 809 configured to collect wall charges (energy) from the panel capacitor Cₚ, store the wall charges (energy), and supply the stored wall charges (energy) to the panel capacitor Cₚ.

However, the apparatus of FIG. 7 may include two falling switching devices, M_{f1} and M_{f2} in a falling pulse applying unit 801 and, accordingly, includes two zener diodes, ZD2 and ZD3. In other words, a temperature section of the PDP may be divided into three sections. When the temperature of the PDP is higher than a first temperature, the second falling switching device M_{f2} having a large zener voltage may be turned on. When the temperature of the PDP is lower than the first temperature but higher than a second temperature, the first falling switching device M_{f1} having a smaller zener voltage may be turned on. When the temperature of the PDP 1 is lower than the second temperature, a first voltage switching device M_{scl} may be tuned on. In other words, the higher the temperature of the PDP, the higher the lowest level of the falling pulse.

In this way, the temperature section of the PDP may be further expanded, and the number of falling switching devices connected to a first voltage source may be increased according to the number of temperature sections of the PDP.

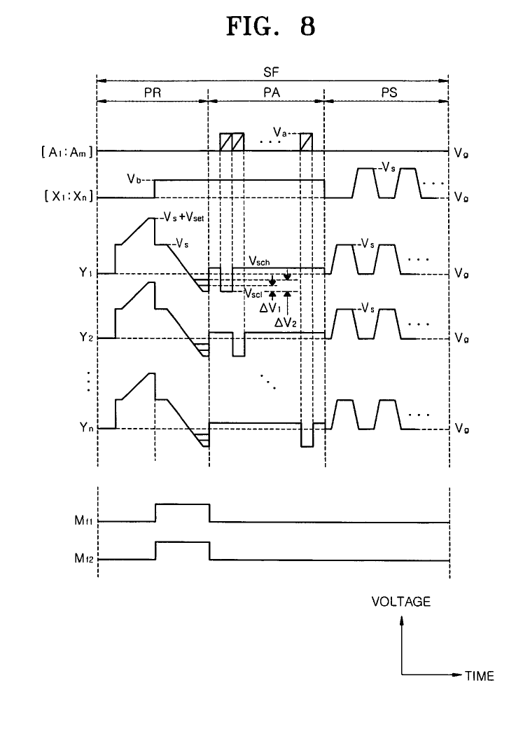

FIG. 8 is a timing diagram illustrating a method of driving a PDP used by the apparatus of FIG. 7 according to another embodiment of the present invention.

Driving signals illustrated in FIG. 8 are similar to the driving signals illustrated in FIG. 6. However, in the driving signals of FIG. 8, the falling pulse may have three types of lowest levels. When the temperature of the PDP is higher than the first temperature, the lowest level of the falling pulse may be higher than the lowest falling voltage V_{scl} by a second potential difference ΔV2. When the temperature of the PDP is lower than the first temperature, but higher than the second temperature, the lowest level of the falling pulse may be higher than the lowest falling voltage V_{scl} by a first potential difference ΔV₁. When the temperature of the PDP is lower than the second temperature, the lowest level of the falling pulse may be the lowest falling voltage V_{scl}.

In this way, whenever the number of temperature sections of the PDP is increased, the lowest level of the falling pulse may be changed.

As described above, the present invention can achieve the following effects. First, the lowest level of a falling pulse during a reset period may be changed according to the temperature of a PDP. Therefore, an address discharge can be stably and uniformly performed regardless of the temperature of the PDP. Second, since the address discharge is performed stably and uniformly, a sustain discharge may also be performed stably and uniformly. Third, the lowest falling voltage and the scan low voltage may be same. Therefore, the number of circuit devices may be reduced, thereby saving manufacturing costs.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A method of driving a plasma display panel (PDP), in which discharge cells are defined in regions where a plurality of electrodes cross one another and a unit frame displaying an image is divided into a plurality of subfields, each subfield comprising a reset period for initializing all discharge cells, an address period for selecting discharge cells to be turned on, and a sustain period for performing a sustain discharge in the selected discharge cells according to a gray scale weight allocated to each subfield, comprising:
applying a falling pulse to first electrodes among the plurality of electrodes during the reset period; and
changing a lowest level of the falling pulse according to a temperature of the PDP.

2. The method as claimed in claim 1, wherein the lowest level of the falling pulse becomes higher as the temperature of the PDP increases.

3. The method as claimed in claim 2, wherein the lowest level of the falling pulse is a first level, when the temperature of the PDP is higher than a first temperature, and the lowest level of the falling pulse is a second level, when the temperature of the PDP is lower than the first temperature, wherein the second level is lower than the first level.

4. The method as claimed in claim 3, wherein the lowest level of the falling pulse is a third level, when the temperature of the PDP is lower than a second temperature, wherein the second temperature is lower than the first temperature, and the lowest level of the falling pulse is the second level, when the temperature of the PDP is lower than the first temperature, but higher than the second temperature, wherein the second level is higher than the third level.

5. The method as claimed in claim 4, including applying a rising pulse to the first electrodes before applying the falling pulse to the first electrodes.

6. The method as claimed in claim 4, including
applying a high level voltage to the first electrodes;
sequentially applying a scan pulse having a low level to the first electrodes during the address period;
transmitting a display data signal having a high level to second electrodes among the plurality of electrodes, in synchronization with the scan pulse, wherein the second electrodes cross the first electrodes.

7. The method as claimed in claim 4, including alternately applying a sustain pulse to the first electrodes during the sustain period, the sustain pulse alternating between a high level and a low level.

8. The method as claimed in claim 7, further including applying a sustain pulse to third electrodes among the plurality of electrodes, the sustain pulse alternating between a high level and a low level, and alternates with the sustain pulse applied to the first electrodes during the sustain period, wherein the third electrodes extend parallel to the first electrodes.

9. The method as claimed in claim 8, further including applying a bias voltage to the third electrodes when the falling pulse is applied to the first electrodes.

10. An apparatus configured to drive a PDP, the apparatus comprising:
a first voltage source configured to supply a first voltage;
a first voltage switching device including a terminal connected to the first voltage source;
at least one falling switching device including terminals connected to the first voltage source in parallel;
zener diodes respectively connected to the other terminal of the at least one falling switching device; and
a falling pulse applying unit configured to output a falling pulse which falls to a first voltage when the first voltage switching device is turned on, wherein the first voltage is a lowest level voltage, and the falling pulse unit is configured to change a lowest level of the falling pulse according to a temperature of the PDP, using the zener diodes having different zener voltages.

11. The apparatus as claimed in claim 10, including a falling switching device connected to a zener diode having a high zener voltage among the zener diodes, wherein as the temperature of the PDP increases, the falling switch device is configured to be turned on, and the lowest level of the falling pulse is changed.

12. The apparatus as claimed in claim 10, including:
a second voltage source and a ground respectively configured to supply a second voltage and a ground voltage;
a second voltage switching device including a terminal connected to the second voltage source;
a ground voltage switching device including a terminal connected to the ground and the other terminal connected to the other terminal of the second voltage switching device; and
a sustain pulse applying unit configured to output a sustain pulse when the second voltage switching device and the ground voltage switching device are alternately turned on.

13. The apparatus as claimed in claim 12, further including:
a third voltage source configured to supply a third voltage;
a first capacitor and a third voltage switching device connected to the third voltage source in parallel;
a main switching device connected between the first capacitor and the third voltage switching device; and
a rising pulse applying unit configured to receive a voltage from the sustain pulse applying unit and output a rising pulse which rises to the third voltage.

14. The apparatus as claimed in claim 12, further including:
a fourth voltage source configured to supply a fourth voltage;
a second capacitor including a terminal connected to the fourth voltage source;
a fifth voltage source configured to supply a fifth voltage;
a fifth voltage switching device connected to the fifth voltage source and the other terminal of the second capacitor;
a scan high switching device and a scan low switching device connected to each other in series between both terminals of the second capacitor; and
a scan pulse applying unit configured to output the fifth voltage when the scan high switching device is turned on and output a scan pulse having the fifth voltage when the fifth voltage switching device and the scan low switching device are turned on.

15. The apparatus as claimed in claim 14, wherein the first voltage source may serve as the fifth voltage source.

16. The apparatus as claimed in claim 12, further including:
an inductor including a terminal connected between the second voltage switching device and the ground switching device of the sustain pulse applying unit;
the inductor including another terminal connected between an energy recovery switching device and an energy supply switching device, wherein terminals of the energy supply switching device are connected to the inductor in parallel;
an energy storage capacitor connected among the other respective terminals of the energy recovery switching device, the energy supply switching device, and the ground; and
an energy recovery unit configured to collect charges from the PDP or supply the charges to the PDP while the sustain pulse is applied.

17. A plasma display device, comprising:
a plasma display panel;
a logic controller configured to process an input signal and output a driving control signal;
a driver configured to receive the driving control signal and output a driving signal to the plasma display panel; and
a temperature sensor configured to sense a temperature inside the plasma display panel,
wherein the driver outputs the driving signal having a lowest level, and the lowest level is changed according to the sensed temperature of the plasma display panel.

18. The device as claimed in claim 17, wherein the driver includes a plurality of falling switching devices connected to a voltage source and zener diodes, wherein as the temperature of the plasma display panel increases, a falling switching device of the plurality of falling switching devices, connected to a zener diode having a high zener voltage among the zener diodes, is turned on.
